(19) United States
(12) Patent Application Publication
(10) Pub. No.: US 2019/0394266 A1
(43) Pub. Date: Dec. 26, 2019

(54) CLUSTER STORAGE SYSTEM, DATA MANAGEMENT CONTROL METHOD, AND NON-TRANSITORY COMPUTER READABLE MEDIUM

(71) Applicant: HITACHI, LTD., Tokyo (JP)

(72) Inventors: Taisuke FUKUYAMA, Tokyo (JP); Kyosuke ACHIWA, Tokyo (JP)

(73) Assignee: HITACHI, LTD., Tokyo (JP)

(21) Appl. No.: 16/291,898

(22) Filed: Mar. 4, 2019

(30) Foreign Application Priority Data
Jun. 20, 2018 (JP) 2018-117268

(51) Int. Cl. H04L 29/08; G06F 3/06

(52) U.S. Cl. CPC H04L 67/1044; H04L 67/1095; G06F 3/067; H04L 67/1097

(57) ABSTRACT

Availability of a cluster storage system to data I/O from a client apparatus is improved. In a cluster storage system including a plurality of nodes and a cluster network, each of the nodes can store data in units of volumes, the cluster storage system includes a plurality of volume groups made up of a plurality of volumes stored in the plurality of nodes, and the nodes synchronize the volumes of the same volume group via a cluster network. When communication in the cluster network is split, the node enables to access at least one volume belonging to a split volume group in which synchronization of volumes is enabled from the client apparatus.

### CROSS-REFERENCE TO PRIOR APPLICATION

This application relates to and claims the benefit of priority from Japanese Patent Application No. 2018-117268 filed on Jun. 20, 2018, the entire disclosure of which is incorporated herein by reference.

### BACKGROUND

The present invention relates to a cluster storage system and the like including a plurality of storage nodes that stores data.

A general Software Defined Storage (SDS) includes a monitoring mechanism for detecting addition and removal of nodes and checking whether there is a node in a down state. For example, in the case of Ceph which is a distributed storage system of typical OSS (Open Source Software), a component called a monitor performs monitoring of an entire cluster. A Ceph storage is an object storage, and each data is divided into certain sizes which are handled as the unit of a Placement Group (PG) which is a group of objects. PG is allocated to any one of object storage devices (OSDs) which are mapped to respective physical devices of each node. A distribution algorithm called CRUSH is used for allocation of PG. An object and an OSD to which the object is allocated can be uniquely determined by a CRUSH's hash computation and it is not necessary to ask the OSD.

In Ceph, when there is no response in a certain period in the heartbeat between OSDs and it is determined that there is a failure, before a monitor detects a failure, all the OSD failures occurred are reported from the OSD to the monitor. The monitor updates a cluster map in accordance with a change in configuration of the OSD and distributes the latest configuration information to respective nodes. It is recommended to ensure redundancy by providing an odd number of monitors to improve fault tolerance. The OSD requests a monitor to provide the latest cluster map and when there is no response in a certain period the OSD acquires a cluster map by communicating with another monitor.

According to a typical means for avoiding occurrence of a split brain when a network between clusters is disconnected in a distributed storage system, a quorum is established in a third location, and leaving nodes which are locked earlier and putting the other nodes into a failover state. In a scalable distributed storage system like Ceph, a majority OSD group is determined on the basis of OSD failure information reported to a monitor, I/O to minority nodes is stopped, and I/O to replicas of objects present in the majority group is continued.

A technology disclosed in Japanese Patent Application Publication No. 2012-173996, for example, is known as a technology for preventing unnecessary service suspension when a split brain occurs in a cluster system.

### SUMMARY

In Ceph, a plurality of same objects are generated and are arranged in different PGs to secure data redundancy. However, when the degree of data redundancy is 3, for example, if the number of minority nodes becomes equal to or larger than the degree of redundancy due to disconnection of a network, I/O to majority nodes is also stopped. That is, I/O processes in an entire cluster system are stopped.

The present invention has been made in view of the above-described circumstance, and an object thereof is to provide a technology capable of improving availability of a cluster storage system with respect to data I/O from client apparatuses.

In order to attain the object, a cluster storage system according to an aspect is a cluster storage system including: a plurality of storage nodes configured to store data used by a client apparatus; and a second network configured to communicably connect the plurality of storage nodes with each other, the second network being different from a first network configured to connect the client apparatus and the storage nodes, wherein each of the storage nodes can store the data in units of volumes, the cluster storage system has a plurality of volume groups made up of a plurality of volumes stored in the plurality of storage nodes, and the plurality of storage nodes storing each volume of the volume group synchronizes volumes of the same volume group via the second network.

According to the present invention, it is possible to improve availability of a cluster storage system with respect to data I/O from client apparatus.

### BRIEF DESCRIPTION OF THE DRAWINGS

FIG. 1 is a diagram illustrating an overall configuration of a computer system according to an embodiment;

FIG. 2 is a diagram illustrating a sub-cluster pair according to an embodiment;

FIG. 3 is a diagram illustrating a configuration of a node management table according to an embodiment;

FIG. 4 is a diagram illustrating a configuration of a volume management table according to an embodiment;

FIG. 5 is a diagram illustrating a configuration of a sub-cluster configuration management table according to an embodiment;

FIG. 6 is a flowchart of a node type recognition and leader election process according to an embodiment;

FIG. 7 is a diagram illustrating an example of a node type recognition and leader election process according to an embodiment;

FIG. 8 is a ladder chart of a node type recognition and leader election process according to an embodiment;

FIG. 9 is a diagram illustrating an example of the state of a sub-cluster pair according to an embodiment;

FIG. 10 is a flowchart of a sub-cluster pair I/O control process according to an embodiment;

FIG. 11 is a ladder chart of an entire control process including a sub-cluster pair I/O control process according to an embodiment;

FIG. 12 is a flowchart of a process at a time of recovery according to an embodiment;

FIG. 13 is a diagram illustrating an example of a process at a time of recovery according to an embodiment; and

FIG. 14 is a ladder chart of a process at a time of recovery according to an embodiment.

### DETAILED DESCRIPTION OF THE EMBODIMENT

Hereinafter, embodiments will be described with reference to the drawings. The embodiments described below are not intended to limit the inventions according to the claims, and all elements and combinations thereof described in the embodiments are not necessarily essential to the solving means for the invention.

In the following description, although information is sometimes described using an expression of an “AAA table,” the information may be expressed by an arbitrary data structure. That is, the “AAA table” may be referred to as “AAA information” in order to show that information does not depend on a data structure.

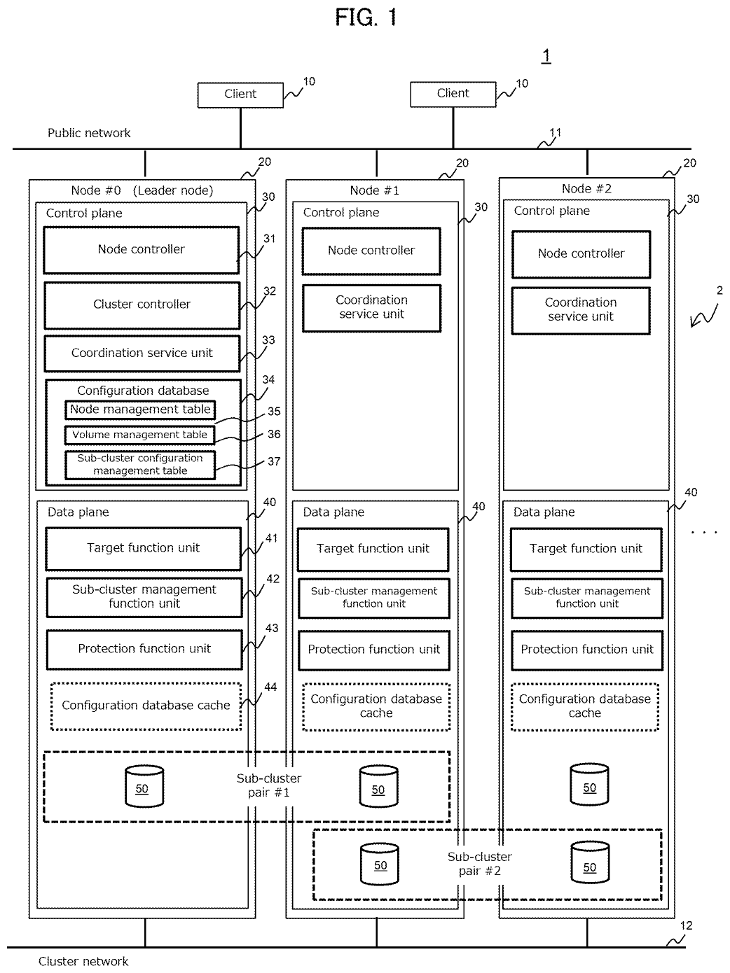

FIG. 1 is a diagram illustrating an overall configuration of a computer system according to an embodiment.

A computer system 1 includes one or more client apparatuses (also referred to as clients) 10 and a cluster storage system 2. The client apparatuses 10 and the nodes 20 of the cluster storage system 2 are coupled via a public network 11 (an example of a first network), for example. Moreover, the nodes 20 of the cluster storage system 2 are coupled via a cluster network 12 (an example of a second network).

The client apparatus 10 executes input/output (I/O) of data (user data) with respect to volumes managed by the cluster storage system 2 and executes various processes.

The public network 11 is a public network such as the Internet, for example. A non-public network may be used instead of the public network 11. The public network 11 is used for I/O of user data from the client apparatus 10 and transmission/reception of management commands to/from the nodes 20, for example. The cluster network 12 is a LAN (Local Area Network), for example, but is not limited to LAN but may be another network. The cluster network 12 is used for performing heartbeat between the nodes 20 that form a sub-cluster pair and copying data when a node of the sub-cluster pair is changed, for example.

The cluster storage system 2 includes a plurality of nodes 20 (storage nodes). The node 20 may be a physical computer, for example. The node 20 includes a control plane 30 and a data plane 40.

The control plane 30 is a control unit that controls a virtual single storage system (a cluster storage system) which is formed across a plurality of nodes 20. The control plane 30 manages a configuration while monitoring and diagnosing an operating state of hardware of the node 20 and the data plane 40. The control plane 30 may be constituted by a virtual computer (VM) and may be constituted by a container, for example.

The control plane 30 includes a node controller 31, a cluster controller 32, a coordination service unit 33, and a configuration database 34. Although the cluster controller 32 has functions executable by the respective nodes 20, the functions are activated by a node 20 (a leader node) serving as a leader only. The node controller 31, the cluster controller 32, and the coordination service unit 33 are formed by a processor of the node 20 executes a program (a data management control program) stored in a memory.

The cluster controller 32 refers to monitoring information notified via the coordination service unit 33 from the node controller 31 of each node 20, identifies an entire state of the cluster storage system 2, and controls the configuration of each node 20 via the node controller 31 of each node 20. Moreover, the cluster controller 32 performs referring to and updating of management tables 35 to 37 to be described later of the configuration database 34.

The node controller 31 is provided independently in the respective nodes 20 and monitors and controls the state of the data plane 40 of the own node 30. For example, the node controller 31 notifies the cluster controller 32 (the cluster controller 32 of the leader node) of the monitoring information of the node 20 via the coordination service unit 33. Moreover, the node controller 31 configures the configuration of the data plane 40 according to the request of the cluster controller 32.

The coordination service unit 33 performs management of the cluster storage system 2 across the nodes 20. Specifically, the coordination service unit 33 monitors the connection state (existence) between the nodes 20 and sends a notification to the node controller 31. The coordination service unit 33 executes a process (a leader election process) of determining a leader node during construction of clusters, occurrence of failures, and failure recovery.

The configuration database 34 stores configuration information and monitoring information which needs to be shared by an entire cluster so that other components (other nodes, the data plane, and the like) can access these pieces of information across nodes. The configuration database 34 is activated on the leader node only. A replica of the configuration database 34 may be stored in a plurality of other nodes so that redundancy is secured.

The configuration database 34 includes a node management table 35, a volume management table 36, and a sub-cluster configuration management table 37. The configuration database 34 is referred to and updated from the cluster controller 32 of the leader node. The detailed configuration of the node management table 35, the volume management table 36, and the sub-cluster configuration management table 37 will be described later.

The data plane 40 controls execution of a read/write process (I/O process) on the user data stored in the volumes managed by the node 20. The data plane 40 may be constituted by a virtual computer (VM) and may be constituted by a container.

The data plane 40 includes a target function unit 41, a sub-cluster management function unit 42, a protection function unit 43, a configuration database cache 44, and one or more volumes 50. The target function unit 41, the sub-cluster management function unit 42, and the protection function unit 43 are formed by a processor of the node 20 executes a program (a data management control program) stored in a memory.

The volume 50 stores user data. The volume 50 is stored in a physical storage device (not illustrated) of the node 20. In the present embodiment, a certain volume 50 is managed in synchronization by a group of a plurality of (in the present embodiment, two) nodes 20.

In the present embodiment, the group (for example, a pair) of nodes that manages a certain volume 50 in synchronization is referred to as a sub-cluster 60 (a sub-cluster pair or a sub-cluster group). A pair of volumes 50 which are synchronization targets of the nodes 20 of the sub-cluster 60 is referred to as a volume pair (a volume group).

The target function unit 41 has a target function in an interface such as iSCSI and FC (Fibre Channel). The target function unit 41 transmits SCSI commands between the client apparatus 10 and a physical storage device that provides volumes of the sub-cluster pair. In the present embodiment, the target function unit 41 determines a data transmission destination node 20 by referring to the configuration database cache 44 cached in the data plane 40 without accessing the configuration database 34 of the control plane 30.

The sub-cluster management function unit 42 controls data services related to the sub-cluster 60 such as thin-provisioning, storage hierarchization, snapshot, or replication. The sub-cluster management function unit 42 manages the configuration information of respective data services uniquely for respective sub-clusters. Among nodes that stores volumes that form the sub-cluster 60, the same configuration information is managed for the volumes 50 that forms the sub-cluster 60. The sub-cluster management function unit 42 checks an existence state of each node 20 on the basis of a heartbeat without via the control plane 30 in cooperation with the sub-cluster management function unit 42 of the node 20 that forms the sub-cluster 60. In a normal state, a volume 50 of one node 20 of the sub-cluster 60 operates in an active state and a volume 50 of the other node 20 operates in a standby state.

The protection function unit 43 performs a user data read/write process and a user data protection across the nodes 20 between the sub-cluster management function unit 42 and the physical storage device. In the present embodiment, the protection function unit 43 prevents loss of volume data when a node failure or the like occurs by making the volume data redundant between sub-cluster pairs. The protection function unit 43 determines a physical storage device of a data transmission destination node 20 by referring to the configuration database cache 44.

The configuration database cache 44 stores the copy data of the node management table 35, the volume management table 36, and the sub-cluster configuration management table 37 stored in the configuration database 34. As for the configuration database cache 44, for example, when a cluster is constructed (the process of each component of the data plane 40 is activated) or when there is a configuration request from the node controller 31, the cluster controller 32 stores the copy data via the node controller 31 of each node 20 by referring to the configuration database 34. The configuration database cache 44 may be provided in a location (a local system memory of the node 20 or the like) that a component of the data plane 40 can refer to. The copy data of the configuration database cache 44 is updated when there is a configuration setting instruction from the node controller 31.

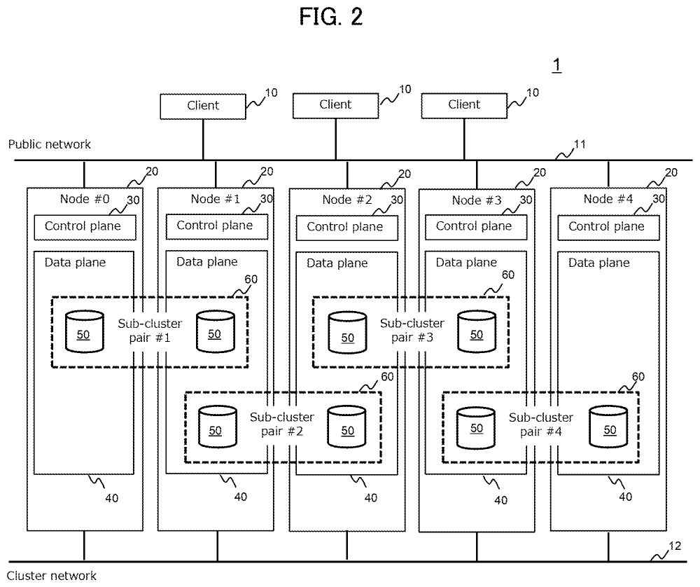

FIG. 2 is a diagram illustrating a sub-cluster pair according to an embodiment.

In the cluster storage system 2 illustrated in FIG. 2, nodes #0 and #1 form a sub-cluster pair #1, nodes #1 and #2 form a sub-cluster pair #2, nodes #2 and #3 form a sub-cluster pair #3, and nodes #3 and #4 form a sub-cluster pair #4. In the normal state of the cluster storage system 2, the data of a management target volume 50 is synchronized by the nodes #0 and #1 of the sub-cluster pair #1, the data of a management target volume 50 is synchronized by the nodes #1 and #2 of the sub-cluster pair #2, the data of a management target volume 50 is synchronized by the nodes #2 and #3 of the sub-cluster pair #3, and the data of a management target volume 50 is synchronized by the nodes #3 and #4 of the sub-cluster pair #4.

Therefore, the data of the volume 50 of the sub-cluster pair #1 can be acquired from any one of the nodes #0 and #1. Similarly, the data of the volume 50 of the sub-cluster pair #2 can be acquired from any one of the nodes #1 and #2, the data of the volume 50 of the sub-cluster pair #3 can be acquired from any one of the nodes #2 and #3, and the data of the volume 50 of the sub-cluster pair #4 can be acquired from any one of the nodes #3 and #4.

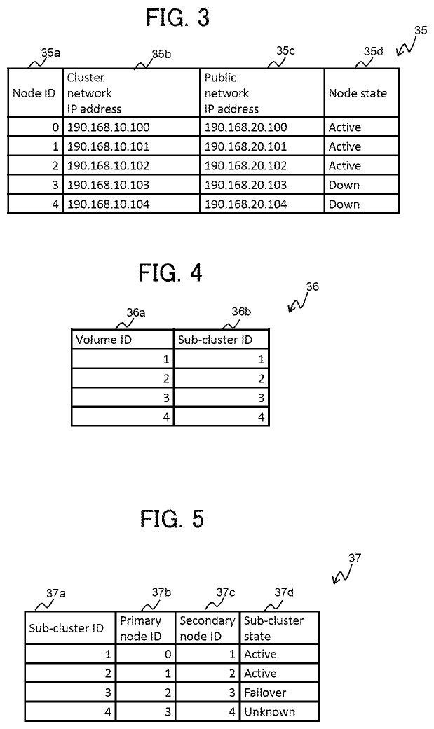

FIG. 3 is a diagram illustrating a configuration of a node management table according to an embodiment.

The node management table 35 stores entries of respective nodes 20. Each entry of the node management table 35 includes the fields of a node ID 35a, a cluster network IP address 35b, a public network IP address 35c, and a node state 35d.

The ID (an identifier) of a node 20 corresponding to the entry is stored in the node ID 35a. An IP address (a cluster network IP address) on the cluster network 12 of the node 20 corresponding to the entry is stored in the cluster network IP address 35b. An IP address (a public network IP address) on the public network 11 of the node 20 corresponding to the entry is stored in the public network IP address 35c. An operating state of the node 20 corresponding to the entry is stored in the node state 35d.

FIG. 4 is a diagram illustrating a configuration of a volume management table according to an embodiment.

The volume management table 36 stores entries for respective volumes 50. The entry of the volume management table 36 includes fields of a volume ID 36a and a sub-cluster ID 36b. The ID (a volume ID) of the volume 50 corresponding to the entry is stored in the volume ID 36a. In the present embodiment, the volumes 50 belonging to the same sub-cluster 60 have the same volume ID. The ID (a sub-cluster ID) of the sub-cluster 60 in which the volume 50 corresponding to the entry belongs (is managed) is stored in the sub-cluster ID 36b.

FIG. 5 is a diagram illustrating a configuration of a sub-cluster configuration management table according to an embodiment.

The sub-cluster configuration management table 37 stores entries related to the configuration of each sub-cluster 60. The entry of the sub-cluster configuration management table 37 includes the fields of a sub-cluster ID 37a, a primary node ID 37b, a secondary node ID 37c, and a sub-cluster state 37d.

The ID (a sub-cluster ID) of the sub-cluster 60 corresponding to the entry is stored in the sub-cluster ID 37a. The ID (a primary node ID) of a node that stores a primary volume (an original volume) of the sub-cluster 60 corresponding to the entry is stored in the primary node ID 37b. The ID (a secondary node ID) of a node that stores a secondary volume (a duplicate volume) is stored in the secondary node ID 37c. The state (a sub-cluster state) of the sub-cluster 60 is stored in the sub-cluster state 37d. Examples of the sub-cluster state include “Active” indicating that the volume 50 of a primary node of the sub-cluster 60 is synchronized with the volume 50 of a secondary node, “Active-Down” indicating that the volume 50 of the primary node of the sub-cluster 60 can be accessed but synchronization with the volume 50 of the secondary node is not made, “Failover” indicating that the volume 50 of the primary node of the sub-cluster 60 cannot be access but the volume 50 of the secondary node can be accessed, and “Unknown” indicating that the state of the sub-cluster 60 cannot be identified.

Next, an operation of a node type recognition and leader node election process performed by each node 20 of the cluster storage system 2 will be described.

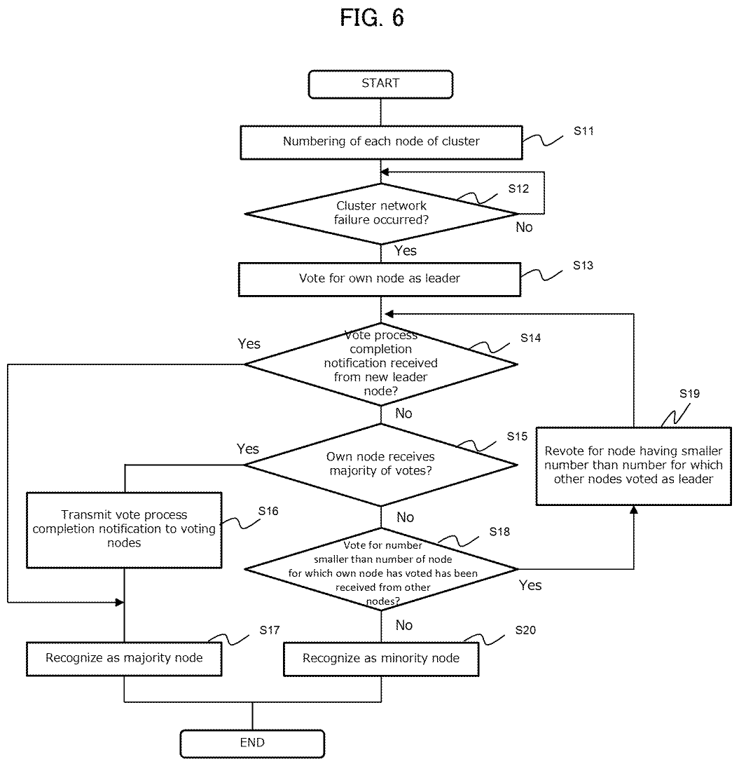

FIG. 6 is a flowchart of a node type recognition and leader election process according to an embodiment.

The node type recognition and leader election process is executed by each node 20 when the cluster storage system 2 is operated.

First, the coordination service unit 33 of the node 20 performs numbering of the respective nodes 20 of the cluster storage system 2 in cooperation with the coordination service unit 33 of the other node 20 (S11). The numbering of the nodes 20 may be made according to the order of node IDs or the order of IP addresses of the nodes, for example. In the present embodiment, the nodes 20 are numbered according to the node ID, for example. When the numbering of the nodes 20 is set in advance, step S11 may not be executed.

Subsequently, the coordination service unit 33 determines whether a network failure has occurred in the cluster network 12 (S12). When a network failure has not occurred (S12: No), the coordination service unit 33 proceeds to step S12.

On the other hand, when a network failure has occurred (S12: Yes), the coordination service unit 33 votes for the own node 20 as a leader (S13). Specifically, the coordination service unit 33 broadcasts a vote (a vote including the number of the own node 20) for selecting the own node 20 as a leader to the cluster network 12 (S13).

Subsequently, the coordination service unit 33 determines whether a vote process completion notification is received from the newly elected leader node (a representative node: a new leader node) (S14). When a vote process completion notification is not received from the new leader node (S14: No), the coordination service unit 33 proceeds to step S15.

On the other hand, when a vote process completion notification is not received from the new leader node (S14: Yes), it is recognized that the own node 20 is a node (a majority node) belonging to a majority group (a largest storage node group) (S17) and the flow ends.

In step S15, the coordination service unit 33 determines whether votes for selecting the own node 20 as a leader are acquired from more than half of the number (a total number) of nodes 20 of the entire cluster storage system 2. When votes for selecting the own node 20 as a leader are acquired from more than half of the total number (S15: Yes), since it means that the own node 20 is a new leader node, the coordination service unit 33 recognizes that the own node 20 is a new leader node, transmits a vote process completion notification to the respective nodes 20 that have voted (S16), recognizes that the own node 20 is a majority node (S17), and ends the process.

On the other hand, when votes for selecting the own node 20 as a leader are not acquired from more than half of the total number (S15: No), the coordination service unit 33 determines that whether a vote for a node of which the number is smaller than the number of the node for which it voted is received from the other node 20 (S18). When a vote for a node of which the number is smaller than the number of the node for which it voted is not received from the other node 20 (S18: No), the coordination service unit 33 recognizes that the own node 20 is a node (a minority node) belonging to a minority (S20) and ends the process.

On the other hand, when a vote for a node of which the number is smaller than the number of the node for which it voted is received from the other node 20 (S18: Yes), the coordination service unit 33 revotes for the node 20 of which the number is smaller than the number of the node for which it voted as a leader (S19) and proceeds to step S14.

According to the node type recognition and leader election process, it is possible to identify whether the own node 20 is a leader node and belongs to a majority group appropriately.

Next, the node type recognition and leader election process will be described in detail.

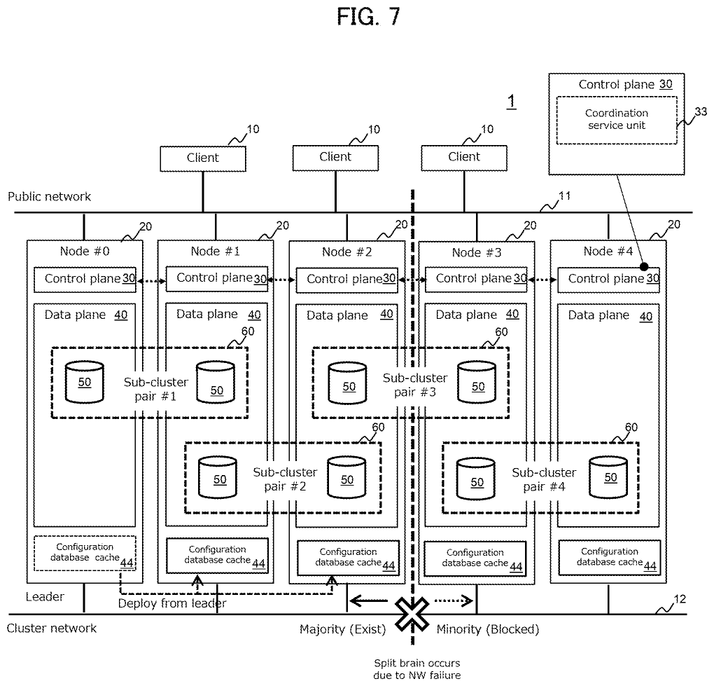

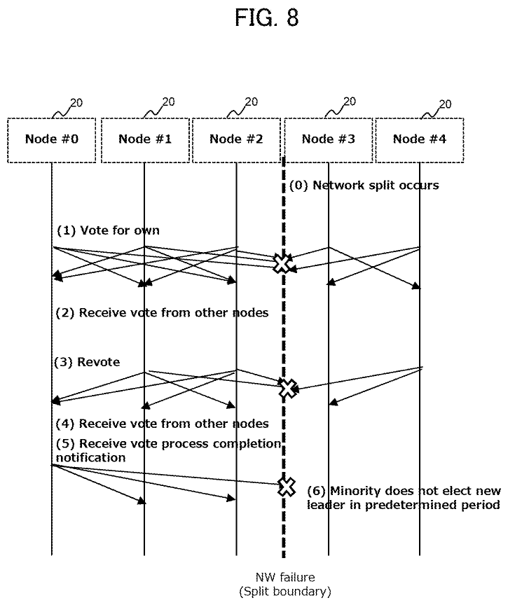

FIG. 7 is a diagram illustrating an example of a node type recognition and leader election process according to an embodiment. FIG. 8 is a ladder chart of a node type recognition and leader election process according to an embodiment.

Here, a node type recognition and leader election process will be described for a case in which, as illustrated in FIG. 7, the cluster storage system 2 includes five nodes 20 of the nodes #0 to #4, in which the nodes #0 and #1 form the sub-cluster pair #1, the nodes #1 and #2 form the sub-cluster pair #2, the nodes #2 and #3 form the sub-cluster pair #3, and the nodes #3 and #4 form the sub-cluster pair #4, and a split brain such that the nodes #0 to #2 are split from the node #3 and #4 occurs in the cluster network 12. The numbers of the nodes #0 to #4 are #0 to #4, respectively.

When a network failure (a split brain) such that the nodes #0 to #2 are split from the nodes #3 and #4 occurs in the cluster network 12 (see (0) in FIG. 8), the coordination service unit 33 of each of the nodes #0 to #4 detects the network failure and votes for the own node 20 as a leader (see (1) in FIG. 8). In this case, the vote of the node #0 is received by the nodes #1 and #2, the vote of the node #1 is received by the nodes #0 and #2, and the vote of the node #2 is received by the nodes #0 and #1. Moreover, the vote of the node #3 is received by the node #4 and the vote of the node #4 is received by the node #3 (see (2) in FIG. 8).

As a result, the nodes #1 and #2 having received the vote for the number (#0) smaller than the number of the node 20 for which the own nodes vote, revote for the smaller number (#0), and the node #4 having received the vote for the number (#3) smaller than the number (#4) of the node for which the own node votes, revote for the smaller number (#3) (see (3) in FIG. 8).

As a result of the revoting, upon receiving the revote for the own number (#0) from the nodes #1 and #2 (see (4) in FIG. 8), the coordination service unit 33 of the node #0 determines that it obtained three votes which are more than half of the total number (5), recognizes that the own node is a new leader node, transmits a vote process completion notification (see (5) in FIG. 8), and recognizes that the own node 20 belongs to the majority group. In this case, the coordination service unit 33 of the node #0 recognized as the new leader node transmits node information (for example, the information on entries corresponding to effective nodes in the node management table 35) of respective nodes (effective nodes: nodes 20 belonging to the majority group) that voted for the own node together with the vote process completion notification. The vote process completion notification is received by the nodes #1 and #2 only due to failures of the cluster network 12. The nodes #1 and #2 having received the vote process completion notification recognize that own nodes 20 belong to the majority group.

On the other hand, since the nodes #3 and #4 do not receive the vote process completion notification, do not obtain three votes which are more than half of the total number (5), and do not receive a vote for the number smaller than the number of the node for which they voted, the nodes #3 and #4 recognize that they belong to the minority group (see (6) in FIG. 8).

According to the above-described process, it is possible to elect (determine) a leader node appropriately from nodes belonging to the majority group. Moreover, the respective nodes 20 can recognize whether they belong to the majority group or the minority group appropriately.

Next, the state of a sub-cluster pair at the time of failure of the cluster network 12 will be described.

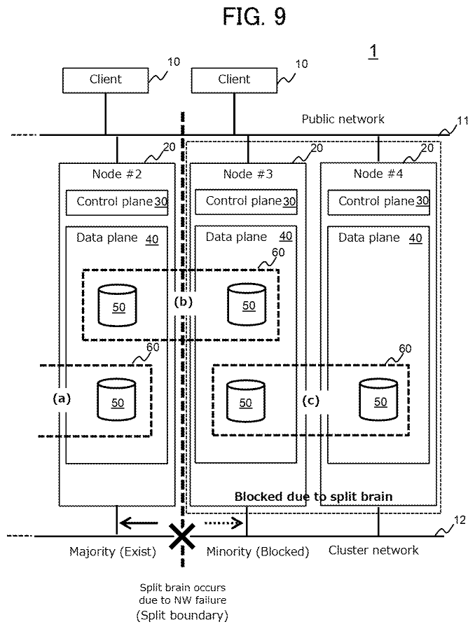

FIG. 9 is a diagram illustrating an example of the state of a sub-cluster pair according to an embodiment.

At the time of failure of the cluster network 12, the sub-cluster 60 may be in cases, for example, including a case in which two nodes 20 forming the sub-cluster 60 belong to the majority group as illustrated in (a) of FIG. 9, a case in which one node 20 of the two nodes 20 forming the sub-cluster 60 belongs to the majority group and the other node 20 belongs to the minority group as illustrated in (b) of FIG. 9, and a case in which the two nodes 20 forming the sub-cluster 60 belong to the minority group as illustrated in (c) of FIG. 9.

In the present embodiment, as illustrated in (a) of FIG. 9, when the two nodes 20 forming the sub-cluster 60 belong to the majority group, since synchronization of the volumes 50 of the sub-cluster 60 can be executed, a state in which I/Os from the client apparatus 10 can be processed is continued. As illustrated in (c) of FIG. 9, when the two nodes 20 forming the sub-cluster 60 belong to the minority group, since synchronization of the volumes 50 of the sub-cluster 60 can be executed, a state in which I/Os from the client apparatus 10 can be processed is continued.

On the other hand, as illustrated in (b) of FIG. 9, when one node 20 of the nodes 20 forming the sub-cluster 60 belongs to the majority group and the other node 20 belongs to the minority group (that is, one volume 50 is stored in the majority node 20 and the other volume 50 is stored in the minority node 20), the state of the sub-cluster 60 is set to Active if the node 20 belonging to the majority group is in the Standby state. In this manner, a volume pair in which one volume of the sub-cluster 60 is stored in the minority node 20 and the other volume is stored in the majority node 20 will be referred to as a split volume pair (a split volume group).

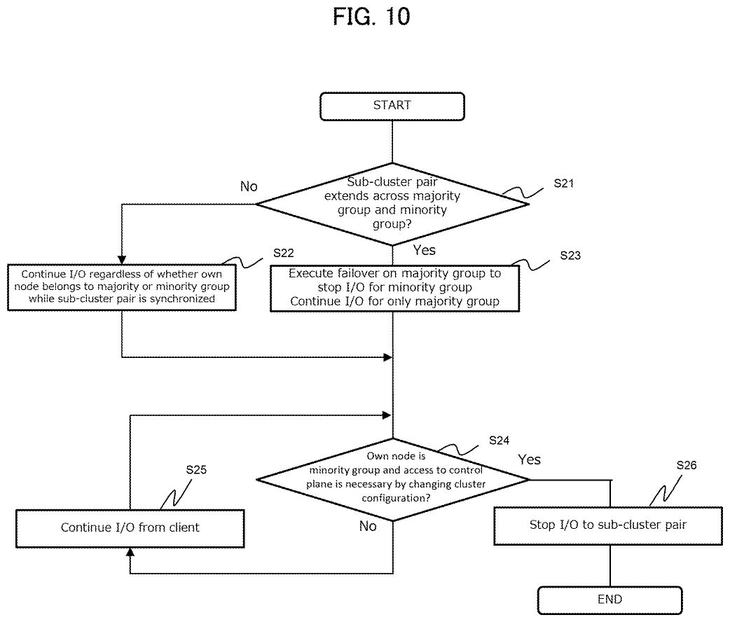

FIG. 10 is a flowchart of a sub-cluster pair I/O control process according to an embodiment.

The sub-cluster pair I/O control process is executed immediately after the node type recognition and leader election process illustrated in FIG. 6 ends, for example.

First, the sub-cluster management function unit 42 of the node 20 determines whether a sub-cluster pair to which the own node 20 belongs extends across the majority group and the minority group, that is, whether one node 20 of the sub-cluster pair belongs to the majority group and the other node 20 belongs to the minority group (S21).

When the sub-cluster pair to which the own node 20 belongs does not extend across the majority group and the minority group (S21: No), since it means that synchronization of the volumes of the sub-cluster 60 can be executed, a state in which I/Os from the client apparatus 10 can be received continuously is maintained (S22) regardless of whether the two nodes 20 forming the sub-cluster pair belong to the majority group or the minority group, and the flow proceeds to step S24.

On the other hand, when the sub-cluster pair to which the own node 20 belongs extends across the majority group and the minority group (S21: Yes), reception of I/Os to the volumes 50 of the sub-cluster pair is stopped if the own node 20 is the minority node and I/Os to the volumes 50 of the sub-cluster pair are received if the own node 20 is the majority node. For example, when the volume 50 of the minority node 20 is in the Active state, Failover is executed so that the volume of the majority node 20 is in the Active state (S23), and the flow proceeds to step S24.

In step S24, the sub-cluster management function unit 42 determines whether the own node 20 is the minority node and it is necessary to access the control plane 30 by changing a cluster configuration. When it is determined that it is not necessary to access the control plane 30 by changing the cluster configuration (S24: No), the sub-cluster management function unit 42 enables to receive I/Os to be received from the client apparatus 10 continuously (S25) and the flow proceeds to step S24.

On the other hand, when it is determined that it is necessary to access the control plane 30 by changing the cluster configuration (S24: Yes), the sub-cluster management function unit 42 stops reception of I/Os to the volume 50 of the sub-cluster pair (S26) and ends the process.

Next, an entire control process including a sub-cluster pair I/O control process in the cluster storage system 2 will be described.

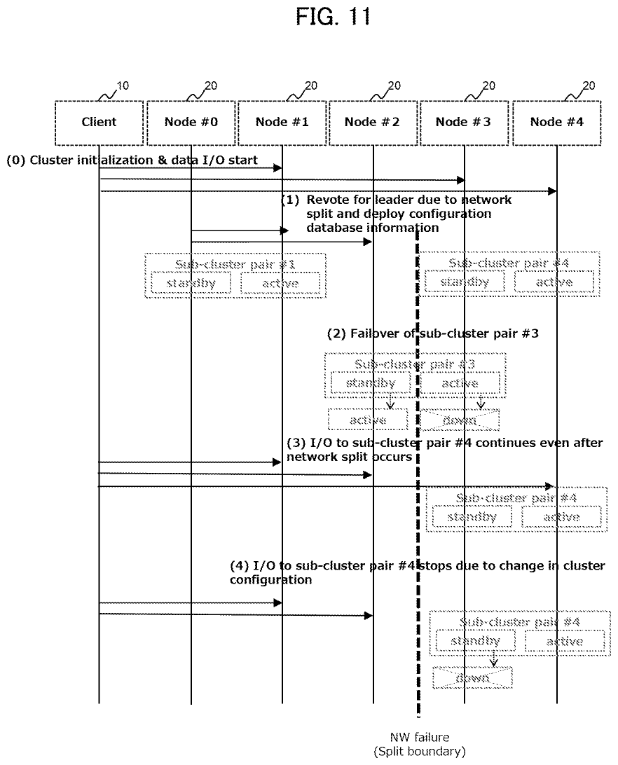

FIG. 11 is a ladder chart of an entire control process including a sub-cluster pair I/O control process according to an embodiment. The process will be described for a case in which the cluster storage system 2 has the configuration illustrated in FIG. 7 and a network split illustrated in FIG. 7 occurs after an operation is executed.

First, the cluster storage system 2 executes a cluster initialization and data I/O start process (see (0) in FIG. 11).

Specifically, during cluster initialization (construction), the cluster controller 32 of a node (a leader node) set as a leader at the initialization time determines optimal resource allocation on the basis of configuration information (for example, NIC (Network Interface Card) information, number of devices, a device capacity, number of CPU cores, and the like) sent to the coordination service unit 33 from the node controller 31 of each node 20. In this case, resources are distributed and arranged according to a known method such as round-robin so that sub-clusters and volumes are not created to concentrate on the resources of a specific node 20.

The cluster controller 32 allocates node IDs sequentially to nodes 20 from which a notification was sent, creates entries including the IP address information of the node 20 and a node state (Active in an initial state) to create the node management table 35. With respect to the IP address of the nodes 20, a leader node may have a DHCP server function so that the IP addresses of the nodes 20 are determined by this function, and the content may be notified to the cluster controller 32. The IP addresses of the nodes 20 may be designated according to an IP address setting command from an administrator, and the designated IP addresses may be notified the node controller 32.

The cluster controller 32 instructs a sub-cluster configuration to the node controllers 31 of the target two nodes 20 on the basis of the determined allocation (allocation of a pair of nodes 20 by which a sub-cluster is created). In this case, when an entry is present in the sub-cluster configuration management table 37, the cluster controller 32 designates sub-cluster ID so as not to overlap the respective entries.

The node controller 31 of each node 20 having received the sub-cluster configuration instruction sends a sub-cluster configuration completion notification to the cluster controller 32 by the coordination service unit 33 when configuration of sub-clusters is completed. The cluster controller 32 adds entries including the created sub-cluster ID of the sub-cluster, the node ID (a primary node ID and a secondary node ID), and the sub-cluster state (Active in the initial state) to the sub-cluster configuration management table 37.

When a command to create the volume 50 is executed from a user (the client apparatus 10), the cluster controller 32 selects a sub-cluster optimal for allocating volumes among the sub-clusters 60 of which the sub-cluster state is Active in the sub-cluster configuration management table 37. As a method for selecting the sub-cluster 60, for example, a method of selecting a sub-cluster to which the smallest number of volumes 50 are allocated in the volume management table 36 may be used. Moreover, the cluster controller 32 instructs a volume creation to the node controller 31 of the node 20 (the primary node) having the primary node ID of the sub-cluster 60 selected from the sub-cluster configuration management table 37 so that the volume ID does not overlap that of the existing volumes 50 in the volume management table 36 and adds entries including the created volume ID and the sub-cluster ID to the volume management table 36.

The node controller 31 of the node 20 having received the volume creation instruction creates volumes 50 in cooperation with the sub-cluster management function unit 42 of the data plane 40 (by executing the thin-provisioning function or the like as necessary). Moreover, the node controller 31 receives the node management table 35, the sub-cluster configuration management table 37, and the volume management table 36 of the configuration database 34 from the cluster controller 32 and stores the information in the tables in a region on the own node 20 as the configuration database cache 44. The protection function unit 43 of the data plane 40 of the primary node creates the replicas of the volumes 50 created in the primary node in the secondary node on the basis of a secondary node ID referred to from the sub-cluster configuration management table (a table having the same content as the sub-cluster configuration management table 37) of the configuration database cache 44 and a cluster network IP address of the node 20 having the same ID as the secondary node ID, referred to from the node management table (a table having the same content as the node management table 35) of the configuration database cache 44, and synchronizes these volumes 50.

When an I/O request for a volume 50 (a target volume) having a predetermined volume ID of the sub-cluster 60 is sent from the client apparatus 10 to the cluster controller 32 of a leader node, the cluster controller 32 specifies a primary node of the sub-cluster 60 managing the target volume 50 and establishes network connection between the primary node and the client apparatus 10. In establishment of network connection, an iSCSI login redirection function which is an existing technology, for example, may be used. Specifically, upon receiving an I/O request from the client apparatus 10, the cluster controller 32 specifies a sub-cluster ID of the sub-cluster 60 serving as the owner of the target volume 50 by referring to the volume management table 36 of the configuration database 34. Subsequently, the cluster controller 32 specifies a primary node ID from matching entries using the sub-cluster ID as a search key by referring to the sub-cluster configuration management table 37. Moreover, the cluster controller 32 specifies a cluster network IP address from entries matching the node ID using the primary node ID as a search key by referring to the node management table 35. The cluster controller 32 transmits the specified cluster network IP address to the client apparatus 10. The client apparatus 10 having received the IP address issues a network connection request to the IP address. The target function unit 41 of the node 20 (that is, the primary node) having received the network connection request notifies the client apparatus 10 of connection approval to establish network connection with the client apparatus 10. After network connection is established, the client apparatus 10 can execute I/O with respect to the primary node having the target volume via the public network 11.

The protection function unit 43 of the primary node having received the I/O request from the client apparatus 10 executes a read/write process (an I/O process) according to the I/O request with respect to a local physical storage device in which the actual data of the volume 50 is to be stored and transmits the same I/O target data to the cluster network IP address specified from the node management table of the configuration database cache 44 with respect to the node 20 (the secondary node) of the secondary node ID specified from the sub-cluster configuration management table of the configuration database cache 44. The protection function unit 43 of the secondary node stores the data in the local physical storage device of the secondary node. In this way, data is synchronized and redundancy is secured.

Subsequently, when a network split occurs in the cluster network 12, the cluster storage system 2 executes a leader election process and a configuration database information deployment process illustrated below (see (1) in FIG. 11).

When the node controller 31 of the node 20 detects that a network split has occurred in the cluster network 12 and a heartbeat between sub-cluster pairs is suspended, the node controller 31 notifies the leader node of the monitoring information with the aid of the coordination service unit 33. In this case, the leader node starts the leader election process of the coordination service unit 33. When a new leader is determined by the leader election process, the coordination service unit 33 of the new leader node activates the cluster controller 32 and the configuration database 34.

Takeover of the information of the configuration database 34 is realized by the following two methods, for example.
From the start of a normal operation of clusters, the information of the configuration database 34 is replicated in advance to a plurality of other nodes 20 and synchronization is achieved. The node 20 that became a new leader due to the leader election process performed at the time of a network failure broadcasts a request for the information of the configuration database 34 to the respective nodes 20 of the cluster and acquires the information of the configuration database 34 from the nodes 20 storing the replica of the configuration database 34. When a node to be elected as a new leader node is restricted to the nodes 20 having the replica of the configuration database 34, since the new leader node already stores the configuration database 34, the request for the information of the configuration database 34 is not necessary. If the number of replicas of the configuration database 34 is more than half of the number of all nodes 20 in the cluster, even if a network split occurs, a leader candidate (a node 20 having the replica of the configuration database 34) will be always included in the nodes included in the majority group. Moreover, by storing the replica of the configuration database 34 in the nodes 20 that use different power supplies by taking power boundary in respective datacenters and racks on which the nodes 20 are mounted into consideration, for example, it is possible to reduce overhead of replication of the configuration database 34 while maintaining high fault-tolerance in actual use.
A leader node can be an arbitrary node 20 of a cluster, and when a new leader node can communicate with the previous leader nodes, the information of the configuration database 34 stored in the previous leader nodes is copied as it is so that the information is taken over to the new leader node. If the new leader node cannot communicate with the previous leader nodes, the new leader node sets the information of the configuration database cache 44 thereof as the information of the configuration database 34 of the cluster and then performs a management table updating process to be described later to thereby update the information.

The cluster controller 32 of the new leader node changes the node state 35d of the entries of the nodes 20 other than the voting node 20 from Active to Down in the node management table 35 of the configuration database 34.

The cluster controller 32 refers to the sub-cluster configuration management table 37 to retrieve entries matching the primary node ID or the secondary node ID using the node ID of a non-voting node (a node whose vote has not arrived due to a network split) as a search key. When an entry matching a condition that a vote from the node 20 of the primary node ID is present and a vote from the node 20 of the secondary node ID is not present is found, the cluster controller 32 changes the sub-cluster state of the entry to Active-Down. Moreover, when an entry matching a condition that a vote from the node of the primary node ID is not present and a vote from the node of the secondary node ID is present is found, the cluster controller 32 changes the sub-cluster state 37d of the entry to Failover. Furthermore, when an entry matching a condition that a vote from the node 20 of the primary node ID and a vote from the node 20 of the secondary node ID are not present is found, the cluster controller 32 changes the sub-cluster state 37d of the entry to Unknown. In the event of a network split, updating of the volume management table 36 does not occur.

When updating of the management tables of the configuration database 34 is completed, the cluster controller 32 of the leader node sends an instructs to update the configuration database cache 44 of each node 20 via the node controller 31 of the voting majority nodes 20. In this way, the same information as that of the configuration database 34 in the latest state is cached in the majority nodes 20.

Subsequently, the cluster storage system 2 executes a Failover process for the sub-cluster pair #3 illustrated below (see (2) in FIG. 11) and executes a process of allowing I/Os to the sub-cluster pair #4 to be continued after the control plane 20 is stopped (see (3) in FIG. 11).

Specifically, the cluster controller 32 of the leader node instructs to execute a Failover process to the node controller 31 of the node 20 of the secondary node ID of the entry of which the sub-cluster state 37d is changed to Failover in the sub-cluster configuration management table 37. The node controller 31 of the node 20 having received the Failover process execution instruction waits for a network reconnection request from the client apparatus 10.

In a primary node having the volume 50 to which I/O is to be stopped, the target function unit 41 executes a process of determining whether reception of I/Os from the client apparatus 10 will be stopped at a time point at which it is recognized that the own node is a node belonging to the minority group without receiving a vote completion notification in the leader election process at a time of the network split. The target function unit 41 of the primary node belonging to the minority group checks whether it is possible to reach the secondary node of an I/O transmission destination by referring to the node management table and the sub-cluster configuration management table of the configuration database cache 44.

When it is possible to reach the secondary node, the target function unit 41 of the primary node continues transmission (synchronization) of I/O to the secondary node without stopping I/O from the client apparatus 10. In FIG. 11, the volumes of the sub-cluster pair #4 made up of the minority nodes 20 only correspond to this case. The volume pair of the sub-cluster pair #4 corresponds to a minority-side volume group.

On the other hand, when it is not possible to reach the secondary node, the target function unit 41 stops reception of I/O from the client apparatus 10 and transmission of I/O to the secondary node. In FIG. 11, the volumes of the sub-cluster pair #3 correspond to this case. The client apparatus 10 in which reception of I/O is stopped issues a network reconnection request to the cluster controller 32 via the public network 11. Here, in order to allow the client apparatus 10 to transmit the network reconnection request to the cluster controller 32, the network reconnection request may be transmitted to a predetermined representative IP address so that a leader node set by the representative IP address receives the network reconnection request. Alternatively, a device in which the representative IP address is set may acquire an IP address of the leader node from the leader node, and when a network reconnection request for the representative IP address is received from the client apparatus 10, the network reconnection request may be redirected to the leader node so that the leader node can receive the network reconnection request.

When the cluster controller 32 of the leader node having received the network reconnection request checks that the received network reconnection request is a connection request for connection to a volume (in this example, the volume of the sub-cluster pair #3) managed by the sub-cluster of which the sub-cluster state 37d is Failover by referring to the volume management table 36 and the sub-cluster configuration management table 37 of the configuration database 34, the cluster controller 32 specifies the public network IP address of the secondary node from the node management table 35 using the secondary node ID of the entry corresponding to the sub-cluster of the sub-cluster configuration management table 37 as a search key and transmits the public network IP address to the client apparatus 10.

The client apparatus 10 having received the public network IP address issues a network connection request to the IP address. The target function unit 41 of the node 20 having received the network connection request notifies the client apparatus 10 of connection approval and establishes network connection with the client apparatus 10. After the network connection is established, the client apparatus 10 can start I/O with respect to the node 20 having the target volume via the public network 11.

When the primary node having received I/O from the client apparatus 10 receives a vote completion notification from the new leader node in the leader election process at a time of the network split and it is recognized that the own node is a node belonging to the majority group, the primary node does not stop read/write to the local physical storage device of the primary node. However, when the sub-cluster state is Active-Down in the sub-cluster configuration management table of the updated configuration database cache 44, the protection function unit 43 of the primary node stops transmission (that is, synchronization) of I/O to the secondary node.

After that, the cluster storage system 2 executes a process of stopping I/O to the sub-cluster pair #3 by changing the cluster configuration illustrated in below (see (4) in FIG. 11).

Specifically, when a cluster configuration is changed in a state in which clusters are not recovered from a network split such as removal of nodes, replacement of storage devices, stopping of network switches, and occurrence of multiple failures, and transmission of I/O to the secondary node by the protection function unit 43 of the primary node fails between nodes belonging to the minority group, the target function unit 43 of the primary node stops reception of I/O from the client apparatus 10 at this time point. The client apparatus 10 in which reception of I/O is stopped issues a network reconnection request to the cluster controller 32 via the public network 11.

When the cluster controller 32 having received the network reconnection request checks that the network reconnection request received from the client apparatus 10 is a connection request for connection to a volume managed by the sub-cluster in which the sub-cluster state 37d is Unknown by referring to the volume management table 36 and the sub-cluster configuration management table 37 of the configuration database 34, the cluster controller 32 determines that a volume pair cannot be synchronized between nodes belonging to the minority group and notifies the client apparatus 10 of connection rejection to allow the client apparatus 10 to recognize that the network connection failed.

Next, a process at a time of recovery in the cluster storage system 2 will be described.

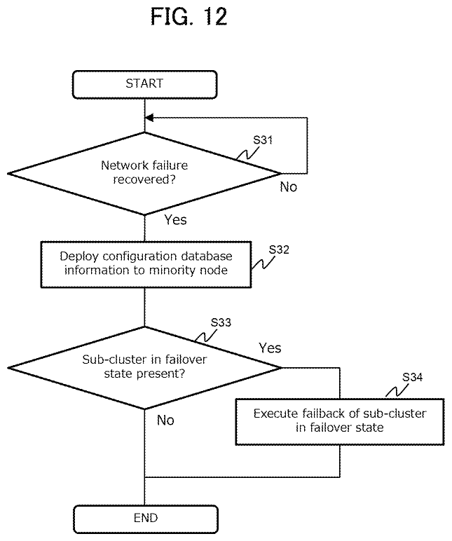

FIG. 12 is a flowchart of a process at a time of recovery according to an embodiment.

The cluster controller 32 determines whether a network failure in the cluster network 12 has been recovered (S31). When the network failure is not recovered (S31: No), the flow proceeds to step S31. When the network failure is recovered (S31: Yes), the cluster controller 32 deploys (transmits) the information of the configuration database 34 to the respective minority nodes 20 (S32).

Subsequently, the cluster controller 32 determines whether a sub-cluster in which the sub-cluster state 37d is set to Failover is present by referring to the sub-cluster configuration management table 37 of the configuration database 34 (S33).

When the sub-cluster in the Failover state is not present (S33: No), the cluster controller 32 ends the process at a time of recovery. On the other hand, when the sub-cluster in the Failover state is present (S33: Yes), the cluster controller 32 executes Failback of the sub-cluster pair in the Failover state (S34). Specifically, the cluster controller 32 transmits a request for allowing reception of I/O to a volume corresponding to the sub-cluster to the node 20 of the primary node ID of the entry of the sub-cluster pair set to Failover in the sub-cluster configuration management table 37, transmits a request for stopping I/O to a volume corresponding to the sub-cluster to the node 20 of the secondary node ID, and sets the sub-cluster state 37d of the corresponding entry to Active-Standby.

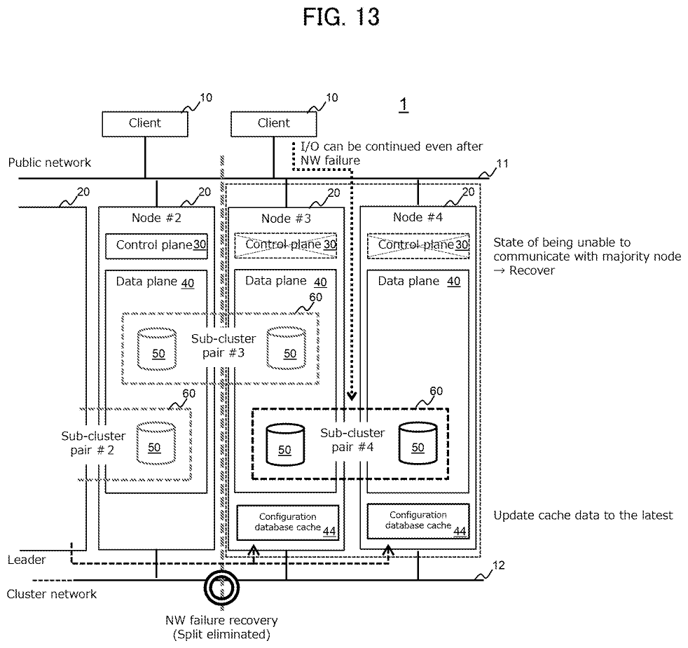

FIG. 13 is a diagram illustrating an example of a process at a time of failure according to an embodiment.

According to the process at a time of recovery, when a network failure is recovered, the nodes 20 belonging to the minority group can communicate with the majority node, and the content of the configuration database cache 44 of the node 20 (the nodes #3 and #4 in FIG. 13) belonging to the minority group is updated to the latest content of the configuration database 34. After that, Failback is executed for the sub-cluster (the sub-cluster #3) formed by the minority nodes 20 and the majority nodes 20, the node 20 of the primary node ID of the entry of the sub-cluster pair is configured to be able to receive I/O to a volume corresponding to the sub-cluster, and the node 20 of the secondary node is made to stop I/O to the volume corresponding to the sub-cluster.

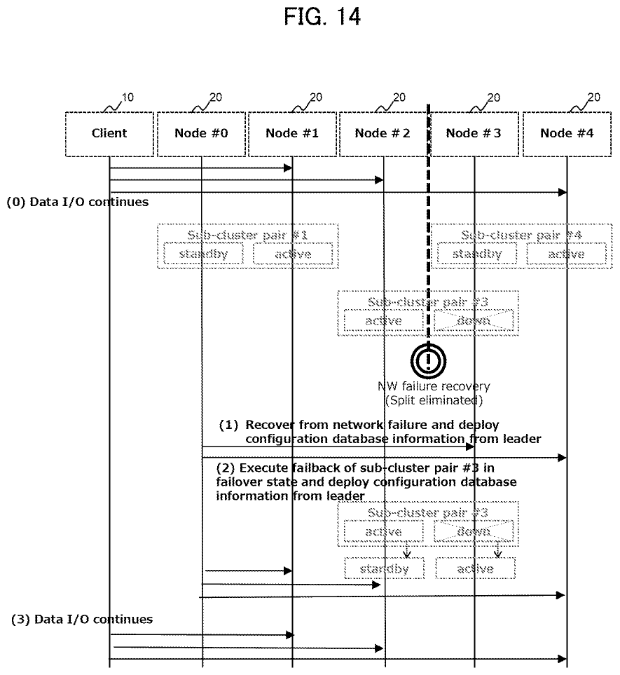

FIG. 14 is a ladder chart of a process at a time of recovery according to an embodiment. The process will be described for a case in which the cluster storage system 2 is in a state immediately after the process (3) illustrated in FIG. 11.

The cluster storage system 2 continues data I/O (see (0) in FIG. 14) In this state, when a primary node and a secondary node belonging to the minority group can communicate with each other, the target function unit 41 of the primary node continues transmission of I/O to the secondary node without stopping I/O from the client apparatus 10. The volumes of the sub-cluster pair #4 correspond to this case.

After that, when the cluster network 12 recovers from the network failure, the node controller 31 of the minority node 20 can send an existence notification to the leader node by the coordination service unit 32. In this case, the cluster controller 32 of the leader node deploys the information of the configuration database 34 to the node controller 31 of the notifying node 20 and updates the configuration database cache 44 of the node 20 (see (1) in FIG. 14).

Subsequently, the cluster controller 32 changes the node state 35d of the node 20 in which the existence notification can be confirmed among the nodes 20 of which the node state 35d is in the Down state in the node management table 35 of the configuration database 34 from Down to Active. Moreover, the cluster controller 32 instructs the node controller 31 of the primary node to update and notify of the sub-cluster state of the sub-cluster of which the sub-cluster state 37d is Active-Down and Unknown in the sub-cluster configuration management table 37 of the configuration database 34. Moreover, the cluster controller 32 instructs the node controller 31 of the secondary node to update and notify of the sub-cluster state of the sub-cluster of which the sub-cluster state 37d is Failover in the sub-cluster configuration management table 37 of the configuration database 34.

The node controller 31 of the instructed node 20 specifies the node ID of the node that forms the sub-cluster together with the own node 20 from the sub-cluster configuration management table of the updated configuration database cache 44, specifies the cluster network IP address from the node management table of the configuration database cache 44, and performs confirmation of response to the other nodes 20 that forms the sub-cluster using the IP address.

When there is no response from the node 20 which is target of confirmation of response, the node controller 31 notifies the leader node of the result. The leader node changes the sub-cluster state 37d of the entry of the target sub-cluster of the sub-cluster configuration management table 37 of the configuration database 34 to Active-down if the sub-cluster state 37d is Unknown and updates the configuration database cache 44 via the node controller 31 of each node 20.

On the other hand, when there is a response from the node 20 which is target of confirmation of response, the node controller 31 notifies the leader node of the result. The cluster controller 32 of the leader node checks the sub-cluster state 37d of the entry of the target sub-cluster of the sub-cluster configuration management table 37 of the configuration database 34.

When the sub-cluster state 37d is Unknown, the cluster controller 32 changes the sub-cluster state 37d to Active and updates the configuration database cache 44 via the node controller 31 of each node 20.

When the sub-cluster state 37d is Active-Down, the cluster controller 32 instructs the node controller 31 of the primary node to synchronize the volume pair. The node controller 31 of the primary node having received the instruction resumes the operation of the stopped protection function unit 43, copies the actual data of the volume in the local physical storage device to the physical storage device on the secondary node so that the volumes are synchronized. When synchronization of the volumes is completed, the node controller 31 of the primary node notifies the leader node of completion of synchronization. The cluster controller 32 of the leader node having received the notification changes the sub-cluster state 37d of the entry of the target sub-cluster of the sub-cluster configuration management table 37 of the configuration database 34 from Active-Down to Active and updates the configuration database cache 44 via the node controller 31 of each node 20.

When the sub-cluster state 37d is Failover, the cluster controller 32 instructs the node controller 31 of the secondary node to synchronize the volume pair and execute Failback. The node controller 31 of the secondary node having received the instruction resumes the operation of the stopped protection function unit 43 and copies the actual data of the volume in the local physical storage device to the physical storage device on the primary node so that the volumes are synchronized. When the synchronization is completed, the secondary node stops reception of I/O from the client apparatus 10.

The client apparatus 10 in which reception of I/O is stopped issues a network reconnection request to the cluster controller 32 via the public network 11. When the cluster controller 32 checks that the network reconnection request received from the client apparatus 10 is a connection request for connection to a volume (in the example of FIG. 14, the volume of the sub-cluster pair #3) managed by the sub-cluster of which the sub-cluster state 37d is Failover by referring to the volume management table 36 and the sub-cluster configuration management table 37 of the configuration database 34, the cluster controller 32 specifies the cluster network IP address of the primary node from the node management table 35 using the primary node ID of the entry corresponding to the sub-cluster of the sub-cluster configuration management table 37 as a search key and transmits the IP address to the client apparatus 10.

The client apparatus 10 having received the IP address issues a network connection request to the received IP address. The target function unit 41 of the node 20 having received the network connection request notifies the client apparatus 10 of the connection approval and establishes network connection with the client apparatus 10. After the network connection is established, the client apparatus 10 can start I/O with respect to the primary node having the target volume via the public network 11. In this way, Failback is completed and each node 20 can enter a state in which each node performs the role corresponding to the setting before a network failure occurred. When the network connection is established and Failback is completed, the primary node notifies the leader node of the completion of Failback. The cluster controller 32 of the notified leader node changes the sub-cluster state 37d of the target entry of the sub-cluster configuration management table 37 of the configuration database 34 from Failover to Active and updates the configuration database cache 44 via the node controller 31 of each node 20. In this way, the cluster storage system 2 can be recovered to a state before a network failure occurred.

The present invention is not limited to the above-described embodiment but can be changed appropriately without departing from the spirit of the present invention.

For example, in the above-described embodiment, when the nodes 20 of a volume pair of a sub-cluster are split into a majority group and a minority group due to a network failure and a Failover process is executed on the volume of the majority node 20 (an example of a first storage node), the volume may be copied to another majority nodes 20 (an example of a second storage node) to form a volume pair with the volume of the node 20 so that the volumes are synchronized. By doing so, it is possible to secure redundancy of volumes appropriately even when a network failure occurs.

In the above-described embodiment, although a sub-cluster pair made up of two nodes has been described as an example of a sub-cluster, the present invention is not limited thereto, and a sub-cluster may be made up of three or more nodes 20. That is, three or more volumes may be managed in synchronization.

In the above-described embodiment, a method of determining a leader node is not limited to the above-described example, and an arbitrary method may be used, and a leader node may be determined randomly among majority nodes, for example.

In the embodiment, a part or all of the processes performed by the processor of the node 20 may be performed by a hardware circuit. In the embodiment, a program may be installed from a program source. The program source may be a program distribution server or a storage medium (for example, a nonvolatile and portable storage medium).

What is claimed is:

1. A cluster storage system comprising:
a plurality of storage nodes configured to store data used by a client apparatus; and
a second network configured to communicably couple the plurality of storage nodes with each other, the second network being different from a first network configured to couple the client apparatus and the storage nodes, wherein
each of the storage nodes can store the data in units of volumes,
the cluster storage system has a plurality of volume groups made up of a plurality of volumes stored in the plurality of storage nodes, and
the plurality of storage nodes storing respective volumes of the volume groups synchronizes volumes of the same volume group via the second network.

2. The cluster storage system according to claim 1, wherein
at least any one of the plurality of storage nodes is configured to:
determine whether communication between the plurality of storage nodes in the second network is split;
determine whether the volume group is a split volume group in which synchronization of volumes in the volume group is not executable when it is determined that the communication in the second network is split; and
enable to access any one volume belonging to the split volume group from the client apparatus.

3. The cluster storage system according to claim 2, wherein
the plurality of storage nodes is configured to:
determine whether own node belongs to a largest storage node group in which the number of storage nodes which can communicate with each other via the second network is the largest among the plurality of storage nodes when it is determined that the communication between the plurality of storage nodes in the second network is split, and
a representative storage node which is a storage node serving as a representative among storage nodes belonging to the largest storage node group is configured to make a volume belonging to the split volume group and stored in storage nodes of the largest storage node group to be accessed from the client apparatus.

4. The cluster storage system according to claim 3, wherein
the representative storage node is configured to:
copy a volume belonging to the split volume group to a second storage node other than a first storage node that stores a volume belonging to the split volume group of the largest storage node group; and
form a new volume group including a volume of the first storage node and a volume of the second storage node, and
the first storage node and the second storage node is configured to synchronize the volumes of the new volume groups.

5. The cluster storage system according to claim 3, wherein
the representative storage node is configured to:
detect elimination of split of the communication between the plurality of storage nodes in the second network; and
apply a content of the volume of the split volume group, which is set to be accessible from the client apparatus, to other volumes of the split volume group when elimination of split of the communication is detected, and
a plurality of storage nodes that store respective volumes of the split volume group pair is configured to start synchronization of the respective volumes.

6. The cluster storage system according to claim 5, wherein
the representative storage node is configured to set a role of a plurality of volumes of the split volume group to a role before the split of the communication between the plurality of storage nodes in the second network occurs.

7. The cluster storage system according to claim 3, wherein
when the volume group does not belong to the largest storage node group but is a minority-side volume group made up of volumes stored only in the plurality of storage nodes which can communicate with each other via the second network, any one of the plurality of storage nodes storing the volumes of the minority-side volume group is configured to allow access from the client apparatus, and
thereafter, when synchronization of volumes of the minority-side volume group is disabled, make access to the volumes from the client apparatus disabled.

8. The cluster storage system according to claim 3, wherein
the plurality of storage nodes are configured to determine whether the own node belongs to a largest storage node group on the basis of the number of other storage nodes that can communicate with each other via the second network and determine that the own node is a representative storage node when the own node belongs to the largest storage node group and the own node is a node having the highest priority.

9. A data management control method by a cluster storage system including:
a plurality of storage nodes configured to store data used by a client apparatus; and
a second network configured to communicably couple the plurality of storage nodes with each other, the second network being different from a first network configured to couple the client apparatus and the storage nodes, wherein
each of the storage nodes can store the data in units of volumes,
the cluster storage system has a plurality of volume groups made up of a plurality of volumes stored in the plurality of storage nodes, and
the plurality of storage nodes storing respective volumes of the volume groups synchronizes volumes of the same volume group via the second network.

10. A non-transitory computer readable medium storing a data management control program executed by a computer that forms a storage node in a cluster storage system including:
a plurality of storage nodes configured to store data used by a client apparatus; and
a second network configured to communicably couple the plurality of storage nodes with each other, the second network being different from a first network configured to couple the client apparatus and the storage nodes, wherein
each of the storage nodes can store the data in units of volumes, and
the cluster storage system has a plurality of volume groups made up of a plurality of volumes stored in the plurality of storage nodes,
the program causes the computer to execute:
determining whether communication between the plurality of storage nodes in the second network is split;
determining whether own node belongs to a largest storage node group in which the number of storage nodes which can communicate with each other via the second network is the largest among the plurality of storage nodes when it is determined that the second network is split;
determining whether the own node is a representative storage node which is a storage node serving as a representative among the largest storage node group when it is determined that the own node belongs to the largest storage node group;
determining whether the volume group in which a volume of the storage node of the largest storage node group is included is a split volume group in which synchronization of volumes in the volume group is disabled when it is determined that the own node is a representative storage node; and
enabling access from the client apparatus to any one of the volumes belonging to the split volume group.
